(19) United States
(12) Patent Application Publication
(10) Pub. No.: US 2025/0183741 A1
(43) Pub. Date: Jun. 5, 2025

(54) ROTOR, ROTOR MANUFACTURING APPARATUS, AND ROTOR MANUFACTURING METHOD

(71) Applicant: NIDEC CORPORATION, Kyoto (JP)

(72) Inventors: Tadashi HOTORI, Kyoto (JP); Takeshi HONDA, Kyoto (JP); Hiroshi KITAGAKI, Kyoto (JP)

(21) Appl. No.: 18/840,493

(22) PCT Filed: Feb. 22, 2023
(86) PCT No.: PCT/JP2023/006400

§ 371 Date: Aug. 22, 2024

(30) Foreign Application Priority Data
Feb. 28, 2022 (JP) 2022-029848

(51) Int. Cl. H02K 1/28; H02K 1/278; H02K 15/035; H02K 15/121

(52) U.S. Cl. CPC H02K 1/28; H02K 1/278; H02K 15/035; H02K 15/121

(57) ABSTRACT

A rotor includes a columnar rotor core extending in the axial direction, and a rotor cover covering a radially outer side of the rotor core. The rotor cover includes a protruding portion protruding to one side in the axial direction with respect to a one-side end surface in the axial direction of the rotor core, and a flange portion extending radially outward at a one-side end portion in the axial direction of the protruding portion.

### CROSS-REFERENCE TO RELATED APPLICATIONS

This is the U.S. national stage of application No. PCT/JP2023/006400, filed on Feb. 22, 2023, and priority under 35 U.S.C. § 119(a) and 35 U.S.C. § 365(b) is claimed from Japanese Patent Application No. 2022-029848, filed on Feb. 28, 2022.

### FIELD OF THE INVENTION

The present invention relates to a rotor, a rotor manufacturing apparatus, and a rotor manufacturing method.

### BACKGROUND

In an inner rotor type DC brushless motor including a permanent magnet type rotor, a configuration including a scattering prevention cover is known in order to prevent scattering of a permanent magnet fixed to the rotor.

For example, conventionally, there is a motor rotor in which an annular rotor magnet arranged concentrically around a rotor shaft and a cover body that is made of nonmagnetic metal and covers an outer peripheral side of the rotor magnet are integrally molded with a molding resin.

Conventionally, there is a motor rotor in which an outer peripheral surface of an annular rotor magnet is covered with a cover body, and an inner diameter side and both axial ends of the rotor magnet are covered with a mold resin. Accordingly, scattering of the magnet can be prevented, and the motor rotor can be used even in liquid.

Incidentally, when a rotor cover covering the radially outer side of a rotor core has a protruding portion protruding in the axial direction of the rotor core, the positioning accuracy of the rotor cover with respect to the rotor core may become a problem. Therefore, in the rotor in which the rotor cover has the protruding portion, a configuration enabling accurate positioning is required.

### SUMMARY

An exemplary rotor according to an embodiment of the present invention includes a columnar rotor core extending in the axial direction, and a rotor cover covering a radially outer side of the rotor core. The rotor cover includes a protruding portion protruding to one side in the axial direction with respect to a one-side end surface in the axial direction of the rotor core, and a flange portion extending radially outward at a one-side end portion in the axial direction of the protruding portion.

An exemplary rotor manufacturing apparatus according to an embodiment of the present invention is a manufacturing apparatus for manufacturing a rotor in which a radially outer side of a columnar rotor core, extending in an axial direction, is covered with a rotor cover, and a one-side end surface of the rotor core in the axial direction is covered with a resin portion. The rotor manufacturing apparatus includes: a first mold that holds the rotor cover that covers the radially outer side of the rotor core in a state where a protruding portion protrudes to one side in the axial direction with respect to a one-side end surface in the axial direction of the rotor core and a flange portion extending radially outward at a one-side end portion in the axial direction of the protruding portion protrudes radially outward; a second mold that is located on one side in the axial direction of the first mold so as to be relatively movable in the axial direction with respect to the first mold, and forms spaces between the second mold and the one-side end surface in the axial direction of the rotor core and between the second mold and the one side in the axial direction of the flange portion of the rotor cover respectively, in a state where the rotor core and the rotor cover are sandwiched between the second mold and the first mold; and a resin injection portion for injecting resin into the spaces. The first mold includes a first pressing portion for pressing the other side in the axial direction of the flange portion of the rotor cover in a state where the rotor core and the rotor cover are sandwiched. The second mold includes a second pressing portion for pressing one side in the axial direction of the flange portion of the rotor cover in a state where the rotor core and the rotor cover are sandwiched.

An exemplary rotor manufacturing method according to an embodiment of the present invention is a manufacturing method of manufacturing a rotor in which a radially outer side of a columnar rotor core, extending in an axial direction, is covered with a rotor cover, and a one-side end surface of the rotor core in the axial direction is covered with a resin portion. The rotor manufacturing method includes: a rotor cover attaching step of inserting the rotor core into the rotor cover, the rotor cover including a side wall portion whose axial length is larger than the axial length of the rotor core and including a flange portion extending radially outward at a one-side end portion in the axial direction of the side wall portion, and positioning the one-side end portion in the axial direction of the rotor cover at a position protruding to the one-side end surface in the axial direction of the rotor core; a mold disposition step of sandwiching the rotor core and the rotor cover between a first mold and a second mold to form spaces with the one-side end surface in the axial direction of the rotor core and with one side in the axial direction of the flange portion of the rotor cover, respectively, and clamping the flange portion; and a resin injection step of injecting resin into the spaces.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a schematic configuration of a rotor according to an embodiment;

FIG. 2 is a cross-sectional view taken along line II-II in FIG. 1;

FIG. 3 is a cross-sectional view taken along line III-III in FIG. 1;

FIG. 4 is a perspective view of the rotor cover illustrated in FIG. 1 as viewed from a bottom side;

FIG. 5 is a diagram describing one step included in a method of manufacturing the rotor according to the embodiment;

FIG. 6 is a schematic view illustrating a state in which a workpiece in which a rotor core and a rotor magnet are inserted into a rotor cover is set in a mold of a rotor manufacturing apparatus; and

FIG. 7 is a schematic view for explaining a resin injection step in the rotor manufacturing method.

### DETAILED DESCRIPTION

Hereinafter, an exemplary embodiment of the present invention will be described in detail with reference to the drawings. The same or corresponding parts in the drawings are denoted by the same reference numerals, and the description thereof will not be repeated. In addition, the dimensions of the components in the drawings do not faithfully represent the actual dimensions of the components, the dimensional ratios of the components, and the like.

Hereinafter, in the description of a rotor 30 and a rotor core 31, a direction parallel to a central axis P of the rotor 30 and the rotor core 31 is referred to as an “axial direction”, “axial”, or “axially”, a direction orthogonal to the central axis P is referred to as a “radial direction”, “radial”, or “radially”, and a direction along an arc centered on the central axis P is referred to as a “circumferential direction”, “circumferential”, or “circumferentially”. However, this definition is not intended to limit the orientation of the rotor 30 and the rotor core 31 during use.

Further, in the following description, expressions such as “fixed”, “connected” and “attached” (hereinafter, fixed or the like) are used not only when the members are directly fixed to each other, but also when the members are fixed via another member. That is, in the following description, the expression such as fixing includes the meaning of direct and indirect fixing between members.

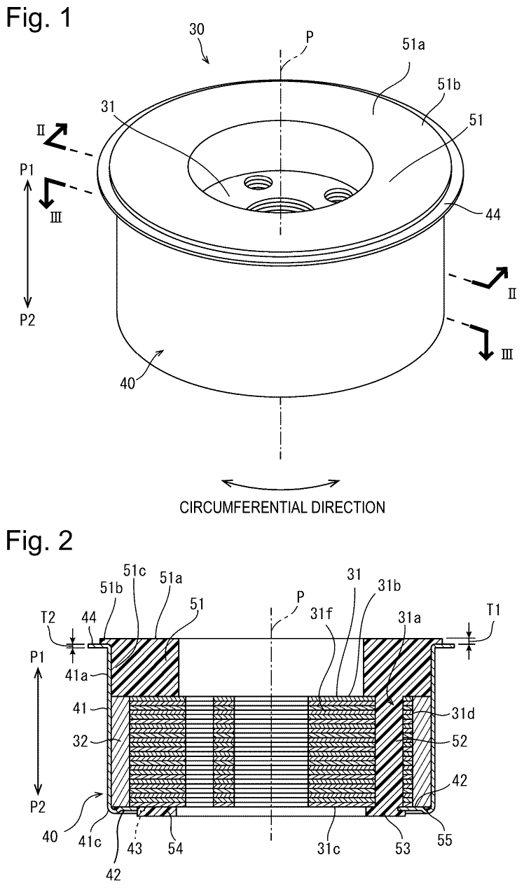

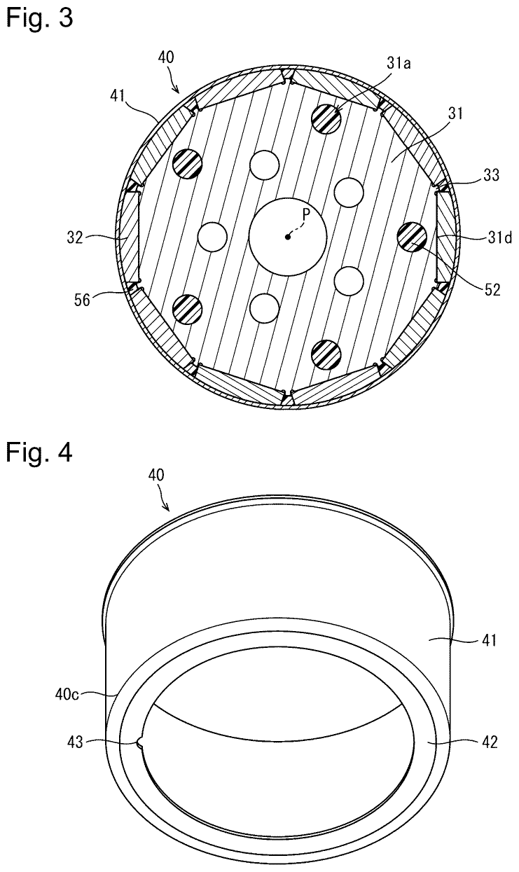

FIG. 1 is a perspective view schematically illustrating a schematic configuration of a rotor 30 according to an embodiment of the present invention. FIG. 2 is a cross-sectional view taken along line II-II in FIG. 1. FIG. 3 is a cross-sectional view taken along line III-III in FIG. 1. FIG. 4 is a perspective view of the rotor cover illustrated in FIG. 1 as viewed from a bottom side. In FIG. 1 and the like, illustration of a shaft that is a rotational axis of a rotor is omitted for convenience of description.

Referring to FIGS. 1 to 4, the rotor 30 is located radially inward of a cylindrical stator (not illustrated) so as to be rotatable about the central axis P. A motor (not illustrated) having such a structure is called an inner rotor type motor. Since the configurations of the motor and the stator are similar to the conventional configurations, detailed description of the motor and the stator is omitted.

The rotor 30 includes a rotor core 31, a plurality of rotor magnets 32, a rotor cover 40, and a resin portion 51.

The rotor core 31 has a polygonal columnar shape extending along the central axis P. The rotor core 31 includes a plurality of plate-like rotor core members 31f having a polygonal shape when the rotor core 31 is viewed in the axial direction. Each of the plurality of rotor core members 31f is made of an electromagnetic steel sheet, and is stacked in the thickness direction.

When the rotor core 31 is viewed in the axial direction, the rotor core 31 has a protruding ridge 33 extending from the one-side end surface 31b to the other-side end surface 31c in the axial direction of the rotor core 31 at each vertex portion of the polygonal rotor core 31. In addition, the rotor core 31 has an arrangement surface 31d between the protruding ridges 33 adjacent to each other in the circumferential direction when the rotor core 31 is viewed in the axial direction.

The rotor core 31 has a plurality of through holes 31a penetrating the rotor core 31 in the axial direction.

The plurality of rotor magnets 32 are positioned radially outward of each side of the polygonal rotor core 31 when viewed in the axial direction of the rotor core 31. That is, the rotor magnet 32 is positioned on each of the arrangement surfaces 31d of the rotor core 31. The rotor magnet 32 has a planar shape on the radially inner side facing the arrangement surface 31d of the rotor core 31. The rotor magnet 32 has a phase shape in which the radially outer side protrudes radially outward when viewed in the axial direction of the rotor core 31. The axial length of the rotor magnet 32 is equivalent to the axial length of the rotor core 31.

The rotor cover 40 is made of, for example, a nonmagnetic metal such as SUS304. The rotor cover 40 covers the rotor core 31 in which the rotor magnet 32 is disposed. The rotor cover 40 includes a side wall portion 41, a flange portion 44, and an extending portion 42.

The side wall portion 41 has a cylindrical shape and covers the radially outer side of the rotor core 31 where the rotor magnet 32 is positioned radially outward. In other words, as particularly shown in FIG. 3, the rotor magnet 32 is positioned between the inner peripheral surface of the side wall portion 41 and the radially outer side of the rotor core 31 when viewed in the axial direction of the rotor core 31. That is, the radially outer shape of the rotor magnet 32 has a shape along the inner peripheral surface of the side wall portion 41.

The side wall portion 41 has a protruding portion 41a protruding to one side P1 in the axial direction with respect to the one-side end surface 31b in the axial direction of the rotor core 31 at one axial end.

The flange portion 44 extends radially outward at the one-side end portion in the axial direction of the protruding portion 41a.

The extending portion 42 extends radially inward at the other-side end portion 41c in the axial direction of the side wall portion 41. A rib protruding to the other side P2 in the axial direction is located in the entire circumferential direction at a connection portion between the extending portion 42 and the other-side end portion 41c. Further, the extending portion 42 has a notch portion 43 at a radially inner end portion.

The resin portion 51 is made of, for example, polybutylene terephthalate (PBT). The resin portion 51 may be made of a thermosetting resin, or may be made of a thermoplastic resin. The resin portion 51 covers a part of the one-side end surface 31b in the axial direction of the rotor core 31. The one-side end portion 51a in the axial direction of the resin portion 51 is located at the one side P1 in the axial direction with respect to the one-side end portion in the axial direction of the protruding portion 41a.

The resin portion 51 has an edge portion 51b and a side portion 51c. The resin portion 51 includes a columnar portion 52 located in the through hole 31a of the rotor core 31, and a retaining portion 53 extending from the other side in the axial direction of the columnar portion 52 to the other side P2 in the axial direction of the extending portion 42 of the rotor cover 40. The resin portion 51 has a rotation prevention portion 54 extending from the other side in the axial direction of the columnar portion 52 up to the notch portion 43 of the rotor cover 40. The resin portion 51 has an inter-magnet filling portion 56 in a space surrounded by the radial inside of the rotor cover 40, the rotor magnet 32, and the protruding ridge 33 of the rotor core 31.

The edge portion 51b extends radially outward from the one-side end portion 51a in the axial direction of the resin portion 51, and is in contact with one side in the axial direction of the flange portion 44. Therefore, deformation of the rotor cover 40, particularly, the flange portion 44, can be suppressed. Therefore, it is possible to suppress vibration generated in the flange portion 44 of the rotor cover 40 when the rotor 30 rotates.

A thickness T1 in the axial direction of the edge portion 51b is larger than a thickness T2 in the axial direction of the flange portion 44. As a result, it is possible to more reliably suppress deformation of the rotor cover 40, particularly, the flange portion 44. Therefore, it is possible to more reliably suppress vibration generated in the flange portion 44 of the rotor cover 40 when the rotor 30 rotates.

The tip on the radially outer side of the edge portion 51b is positioned radially outward of the radially outer side of the protruding portion 41a. Accordingly, deformation of the flange portion 44 can be suppressed. Therefore, it is possible to suppress vibration generated in the flange portion 44 when the rotor 30 rotates.

The side portion 51c is in contact with the radially inner side of the protruding portion 41a. As a result, the side portion 51c of the resin portion 51 comes into contact with the radially inner side of the protruding portion 41a of the rotor cover 40. Therefore, during rotation of the rotor 30, the side portion 51c of the resin portion 51 suppresses deformation in the radial direction of the protruding portion 41a of the rotor cover 40. Therefore, when the rotor 30 rotates, vibration generated in the protruding portion 41a of the rotor cover 40 protruding in the axial direction of the rotor core 31 can be suppressed by the side portion 51c of the resin portion 51.

Therefore, the rotor core 31, the rotor magnet 32, and the rotor cover 40 are integrated by the resin portion 51.

The retaining portion 53 restricts the movement of the rotor cover 40 to the one side P1 in the one axial direction. Therefore, the rotor cover 40 can be prevented from coming off from the rotor core 31.

Furthermore, the rotation prevention portion 54 restricts the movement of the rotor cover 40 in the circumferential direction. Therefore, it is possible to prevent the rotor cover 40 from rotating with respect to the rotor core 31.

As described above, the rotor 30 includes the rotor core 31 and the rotor cover 40. The rotor core 31 has a columnar shape extending in the axial direction. The rotor cover 40 covers the radially outer side of the rotor core 31. In addition, the rotor cover 40 includes the protruding portion 41a protruding to one side in the axial direction with respect to the one-side end surface 31b in the axial direction of the rotor core 31, and the flange portion 44 extending radially outward at the one-side end portion in the axial direction of the protruding portion 41a.

In the above-described configuration, when the rotor 30 is manufactured, the rotor cover 40 can be positioned with respect to the rotor core 31 with reference to the flange portion 44. Therefore, the positioning accuracy of the rotor cover 40 with respect to the rotor core 31 can be improved.

The flange portion 44 of the rotor cover 40 and the edge portion 51b of the resin portion 51 are located in the entire circumferential direction of the rotor cover 40. As a result, it is possible to more stably suppress the vibration generated in the rotor cover 40 when the rotor 30 rotates.

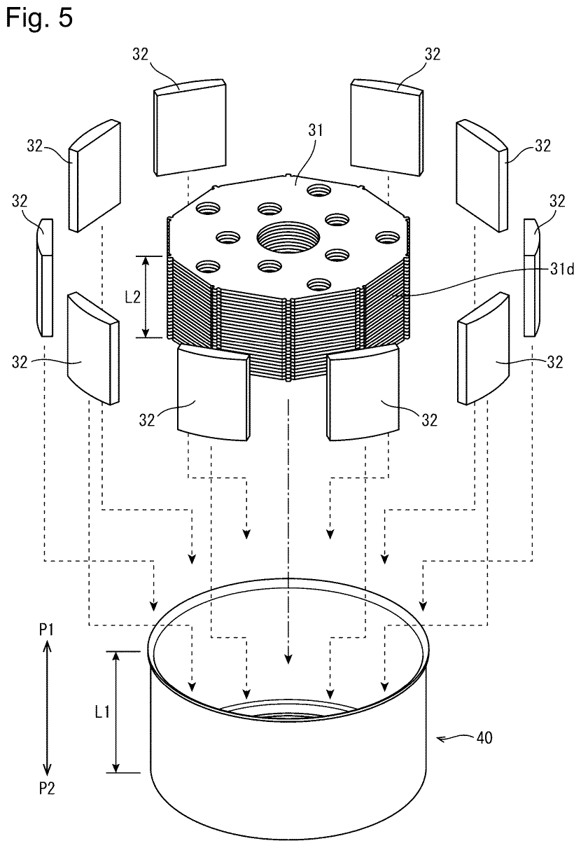

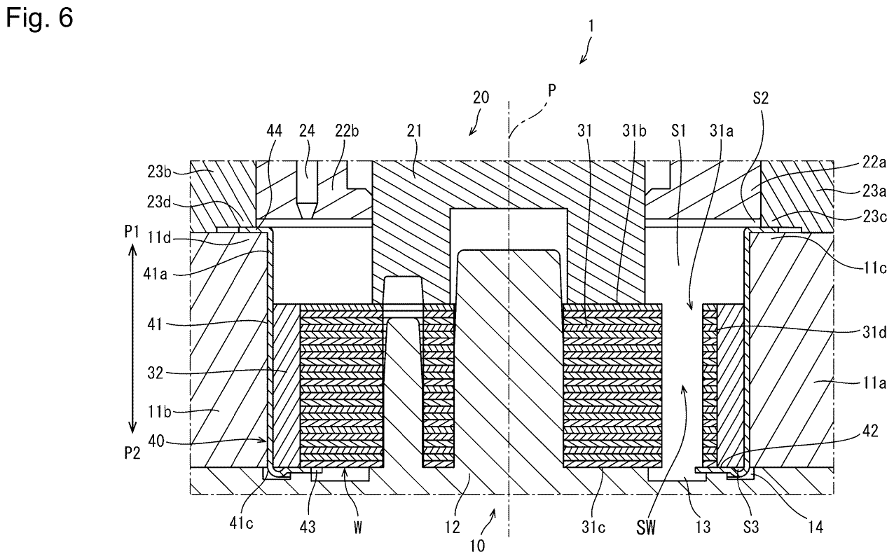

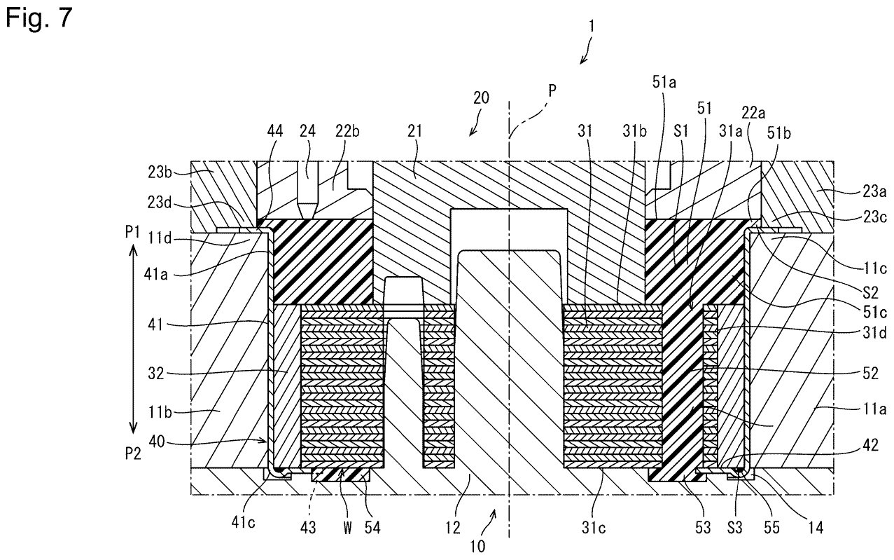

FIG. 5 is a diagram describing one step included in a method of manufacturing the rotor 30 according to the embodiment. FIG. 6 is a schematic view illustrating a state in which a workpiece in which the rotor core 31 and the rotor magnets 32 are inserted into the rotor cover 40 is set in a mold of a rotor manufacturing apparatus. FIG. 7 is a schematic view describing a resin injection step in the rotor manufacturing method.

A method of manufacturing the rotor 30 according to the embodiment will be described with reference to FIGS. 5 to 7. The method for manufacturing the rotor 30 includes a rotor cover attaching step, a mold disposition step, and a resin injection step.

First, in the rotor cover attaching step, the rotor core 31 and the rotor magnet 32 are inserted into the rotor cover 40 with reference to FIGS. 1 to 4 described above in addition to FIG. 5, and the one-side end portion in the axial direction of the side wall portion 41 of the rotor cover 40 is positioned at a position protruding with respect to the one-side end surface 31b in the axial direction of the rotor core 31.

More specifically, it is noted as follows. First, while the rotor magnet 32 is positioned on the arrangement surface 31d of the rotor core 31, the rotor core 31 and the rotor magnet 32 are inserted into the rotor cover 40. At this time, the rotor core 31 and the rotor magnet 32 are moved with respect to the rotor cover 40 from the one side P1 to the other side P2 in the axial direction of the rotor core 31 to a position where the rotor core 31 and the rotor magnet 32 are in contact with one side in the axial direction of the extending portion 42 of the rotor cover 40. Therefore, the rotor core 31 and the rotor magnet 32 can be positioned with respect to the rotor cover 40 by the extending portion 42.

As a result, the radially outer sides of the rotor core 31 and the rotor magnet 32 are covered with the rotor cover 40.

The length L1 in the axial direction of the rotor cover 40 is larger than the length L2 in the axial direction of the rotor core 31. Therefore, the one-side end portion in the axial direction of the side wall portion 41 of the rotor cover 40 protrudes with respect to the one-side end surface 31b in the axial direction of the rotor core 31. That is, the one-side end portion of the side wall portion 41 of the rotor cover 40 corresponds to the above-described protruding portion 41a.

The workpiece W configured of the rotor core 31, the rotor magnets 32, and the rotor cover 40 in this manner is disposed in the rotor manufacturing apparatus 1.

Here, the configuration of the rotor manufacturing apparatus 1 will be described with reference to FIG. 6 in particular. The rotor manufacturing apparatus 1 includes a first mold 10, a second mold 20, and a resin injection portion 24.

The first mold 10 holds the rotor cover 40 covering the radially outer side of the rotor core 31 in a state in which the protruding portion 41a protrudes to the one side P1 in the axial direction with respect to the one-side end surface 31b in the axial direction of the rotor core 31.

More specifically, the first mold 10 includes a base mold 12 and side molds 11a and 11b. A space SW in which the workpiece W is accommodated is formed by the base mold 12 and the side molds 11a and 11b. The side molds 11a and 11b may be integrated or may be separate.

The base mold 12 has a placement surface on which the workpiece W can be placed. More specifically, the base mold 12 includes a first recess 13 and a second recess 14. The first recess 13 is located at the other side P2 in the axial direction of the through hole 31a of the rotor core 31 with respect to the workpiece W placed on the placement surface. The second recess 14 has a shape capable of accommodating the rib of the extending portion 42 of the rotor cover 40 of the workpiece W placed on the placement surface.

The side molds 11a and 11b constitute side walls of the space SW that accommodates the workpiece W. That is, the side molds 11a and 11b cover the radially outer side of the rotor cover 40 in a state where the workpiece W is placed on the placement surface of the base mold 12.

In addition, first pressing portions 11c and 11d for placing the flange portion 44 of the rotor cover 40 are positioned at one-side end portions in the axial direction of the side molds 11a and 11b. The first pressing portions 11c and 11d press the other side in the axial direction of the flange portion 44 of the rotor cover 40 in a state where the workpiece W is sandwiched between the first mold 10 and the second mold 20.

The second mold 20 is located on the one side P1 in the axial direction of the first mold 10 so as to be relatively movable in the axial direction with respect to the first mold 10. In a state where the workpiece W is sandwiched between the second mold 20 and the first mold 10, a space S1 is formed between the second mold 20 and the one-side end surface 31b in the axial direction of the rotor core 31, and a space S2 is formed between the second mold 20 and the one side in the axial direction of the flange portion 44 of the rotor cover 40. More specifically, the second mold 20 includes a central mold 21, inner molds 22a and 22b, and outer molds 23a and 23b.

The central mold 21 presses the workpiece W placed on the placement surface of the base mold 12 around the central axis P of the one-side end surface 31b in the axial direction of the rotor core 31.

The inner molds 22a and 22b are positioned radially outward of the central mold 21, and form the space S1 with the one-side end surface 31b in the axial direction of the rotor core 31.

The outer molds 23a and 23b are positioned radially outward of the inner molds 22a and 22b. The outer molds 23a and 23b have second pressing portions 23c and 23d at positions facing the first pressing portions 11c and 11d of the side molds 11a and 11b in the axial direction. The second pressing portions 23c and 23d press one side in the axial direction of the flange portion 44 of the rotor cover 40 in a state where the workpiece W is sandwiched between the first mold 10 and the second mold 20.

In a state where the workpiece W is sandwiched, a space S2 is formed between the inner molds 22a and 22b and the outer molds 23a and 23b described above and one side in the axial direction of the flange portion 44 of the rotor cover 40.

The resin injection portion 24 is provided in the inner mold 22b of the second mold 20, and resin is injected into the space formed by the first mold 10, the second mold 20, and the workpiece W.

With reference to FIG. 6 in particular, in the mold disposition step, by sandwiching the workpiece W between the first mold 10 and the second mold 20 of the rotor manufacturing apparatus 1 described above, the space S1 is formed between the second mold 20 and the one-side end surface 31b in the axial direction of the rotor core 31, and the space S2 is formed between the second mold 20 and the one side in the axial direction of the flange portion 44 of the rotor cover 40. In the mold disposition step, the flange portion 44 is clamped by the first pressing portions 11c and 11d of the first mold 10 and the second pressing portions 23c and 23d of the second mold 20. Therefore, the flange portion 44 of the rotor cover 40 can be accurately positioned with respect to the first mold 10 and the second mold 20. As a result, the rotor cover 40 can be accurately positioned with respect to the first mold 10 and the second mold 20.

Further, in the mold disposition step, the first recess 13 of the first mold 10 is positioned at the other side P2 in the axial direction of the through hole 31a of the rotor core 31.

In the resin injection step, with reference to FIG. 7 in particular, resin is injected from the resin injection portion 24 into the first mold 10 and the second mold 20 to mold the workpiece W. More specifically, in the resin injection step, the resin is injected into each of the space S1, the space S2, the through hole 31a of the rotor core 31, and the first recess 13.

In the resin injection step, the resin portion 51 is formed by injecting resin into the space S1. In addition, the edge portion 51b is formed by injecting resin into the space S2.

In addition, the columnar portion 52 is formed by injecting resin into the through hole 31a of the rotor core 31. Further, in the resin injection step, resin is injected into the first recess 13 of the first mold 10 through the through hole 31a of the rotor core 31, so that the rotation prevention portion 54 that restricts the movement of the extending portion 42 of the rotor cover 40 in the circumferential direction of the rotor cover 40 and the retaining portion 53 that restricts the movement of the extending portion 42 in to the one side P1 in the axial direction are formed on the other-side end surface 31c in the axial direction of the rotor core 31. The rotation prevention portion 54 and the retaining portion 53 function as restricting portions that restrict the movement of the rotor cover 40.

With reference also to FIG. 3, in the resin injection step, resin passes through the space on the side of the rotor core 31 from the one-side end surface 31b in the axial direction of the rotor core 31, and flows into the back side of the rib of the extending portion 42 of the rotor cover 40. That is, in the resin injection step, the resin passes from the space S1 through a space surrounded by the radially inner side of the rotor cover 40, the rotor magnet 32, and the protruding ridge 33 of the rotor core 31, and is poured into the space S3 formed on the one side P1 in the axial direction of the rib of the extending portion 42 of the rotor cover 40. In the resin injection step, the resin flows into these spaces to form the inter-magnet filling portion 56 and a rib rear resin portion 55.

As described above, the rotor manufacturing apparatus 1 is a manufacturing apparatus for manufacturing the rotor 30 in which the radially outer side of the columnar rotor core 31 extending in the axial direction is covered with the rotor cover 40 and the one-side end surface 31b of the rotor core 31 in the axial direction is covered with the resin portion 51. The rotor manufacturing apparatus 1 includes the first mold 10, the second mold 20, and the resin injection portion 24.

The first mold 10 holds the rotor cover 40 covering the radially outer side of the rotor core 31 in a state where the protruding portion 41a protrudes to the one side P1 in the axial direction with respect to the one-side end surface 31b in the axial direction of the rotor core 31 and the flange portion 44 extending radially outward protrudes radially outward at the one-side end portion in the axial direction of the protruding portion 41a.

The second mold 20 is located on one side in the axial direction of the first mold 10 so as to be relatively movable in the axial direction with respect to the first mold 10, and in a state where the rotor core 31 and the rotor cover 40 are sandwiched between the second mold 20 and the first mold 10, the spaces S1 and S2 are formed between the second mold 20 and the one-side end surface 31b in the axial direction of the rotor core 31 and between the second mold 20 and the one side in the axial direction of the flange portion 44 of the rotor cover 40, respectively.

The resin injection portion 24 injects resin into the spaces S1 and S2.

The first mold 10 includes the first pressing portions 11c and 11d for pressing the other side in the axial direction of the flange portion 44 of the rotor cover 40 in a state where the rotor core 31 and the rotor cover 40 are sandwiched.

The second mold 20 includes the second pressing portions 23c and 23d for pressing one side in the axial direction of the flange portion 44 of the rotor cover 40 in a state where the rotor core 31 and the rotor cover 40 are sandwiched.

According to the rotor manufacturing apparatus 1, the rotor core 31 and the rotor magnet 32 can be positioned with respect to the rotor cover 40 by the extending portion 42. In addition, the rotor cover 40 can be accurately positioned with respect to the first mold 10 and the second mold 20. As a result, the rotor 30 with high dimensional accuracy can be produced.

Further, according to the rotor manufacturing apparatus 1, in a state where the flange portion 44 of the rotor cover 40 is clamped by the first pressing portions 11c and 11d of the first mold 10 and the second pressing portions 23c and 23d of the second mold 20, resin can be injected into each of the space S1 formed with the one-side end surface 31b in the axial direction of the rotor core 31 and the space S2 formed with the one side in the axial direction of the flange portion 44 of the rotor cover 40.

As a result, the resin portion 51 is formed in a range from the one-side end surface 31b in the axial direction of the rotor core 31 to one side in the axial direction of the flange portion 44 of the rotor cover 40.

Therefore, it is possible to obtain the rotor 30 in which the vibration generated in the rotor cover 40, particularly in the flange portion 44, during the rotation of the rotor 30 can be suppressed by the resin portion 51.

Further, as described above, the rotor manufacturing method is a manufacturing method of manufacturing the rotor 30 in which the radially outer side of the columnar rotor core 31 extending in the axial direction is covered with the rotor cover 40 and the one-side end surface 31b of the rotor core 31 in the axial direction is covered with the resin portion 51. Here, the rotor cover 40 includes the side wall portion 41 having the axial length L1 larger than the axial length L2 of the rotor core 31, and the flange portion 44 extending radially outward at the one-side end portion in the axial direction of the side wall portion 41.

The rotor manufacturing method includes a rotor cover attaching step, a mold disposition step, and a resin injection step.

In the rotor cover attaching step, the rotor core 31 is inserted into the rotor cover 40, and the one-side end portion in the axial direction of the rotor cover 40 is positioned at a position protruding with respect to the one-side end surface 31b in the axial direction of the rotor core 31.

In the mold disposition step, by sandwiching the rotor core 31 and the rotor cover 40 between the first mold 10 and the second mold 20, the space S1 is formed with the one-side end surface 31b in the axial direction of the rotor core 31, and the space S2 is formed with one side in the axial direction of the flange portion 44 of the rotor cover 40. In the mold disposition step, the flange portion 44 is clamped along with the formation of the spaces S1 and S2.

In the resin injection step, resin is injected into the space S1 and the space S2. As a result, the rotor core 31, the rotor magnet 32, and the rotor cover 40 are molded and integrated by the resin.

According to the rotor manufacturing method, the rotor 30 with high assembly accuracy can be produced. Further, by the rotor manufacturing method, the resin portion 51 is formed from the one-side end surface 31b in the axial direction of the rotor core 31 to one side in the axial direction of the flange portion 44 of the rotor cover 40. As a result, it is possible to obtain the rotor 30 in which the vibration generated in the rotor cover 40, particularly in the flange portion 44, during the rotation of the rotor 30 can be suppressed by the resin portion 51. Moreover, in the process of manufacturing the rotor 30, it is not necessary to prepare a work-in-process in which the rotor core 31 and the rotor magnet 32 are assembled, so that the production efficiency of the rotor 30 is improved.

In addition, in the rotor manufacturing method, the rotor core 31 has the through hole 31a axially penetrating the rotor core 31, the rotor cover 40 has the extending portion 42 extending radially inward at the other-side end portion 41c in the axial direction, and the first mold 10 has the first recess 13.

In the mold disposition step, when the rotor core 31 and the rotor cover 40 are sandwiched between the first mold 10 and the second mold 20, the first recess 13 of the first mold 10 is positioned at the other side P2 in the axial direction of the through hole 31a of the rotor core 31.

In the resin injection step, resin is further injected into the first recess 13 of the first mold 10 through the through hole 31a of the rotor core 31 to form a restricting portion that restricts at least one of the movement of the extending portion 42 of the rotor cover 40 in the circumferential direction of the rotor cover 40 and the movement of the extending portion 42 in the axial direction, on the other-side end surface 31c in the axial direction of the rotor core 31.

Thus, the movement of the rotor cover 40 can be restricted by the resin flowing into the first recess 13. Therefore, a structure for preventing the rotor cover 40 from coming off or being removed from the rotor core 31 is obtained.

While the embodiment of the present invention has been described above, the above embodiment is merely an example for implementing the present invention. Thus, the present invention is not limited to the embodiment described above, and the embodiment described above may be appropriately modified and implemented without departing from the scope of the present invention.

In the above embodiment, it has been described that the rotor core 31 has a polygonal columnar shape, but the present invention is not limited thereto, and the rotor core 31 may have another shape. For example, the rotor core may have a cylindrical shape.

In the above embodiment, the rotor cover 40 is made of a nonmagnetic metal such as SUS304. However, the rotor cover may be made of another non-magnetic material. For example, the rotor cover may be made of resin. In addition, the material of the rotor cover may be a material other than a non-magnetic material.

In the above embodiment, the rotor cover 40 has the extending portion 42 extending radially inward at the other-side end portion 41c in the axial direction of the side wall portion 41, but the present invention is not limited thereto. The extending portion may be omitted in the rotor cover.

In the above embodiment, it has been described that the rotor core 31, the rotor magnet 32, and the rotor cover 40 are molded by the resin portion 51, but the rotor core 31, the rotor magnet 32, and the rotor cover 40 may be integrated by another method. For example, the rotor core, the rotor magnet, and the rotor cover may be integrated by a mechanical method such as caulking.

In the above embodiment, it has been described that the thickness T1 in the axial direction of the edge portion 51b is larger than the thickness T2 in the axial direction of the flange portion 44. However, the present invention is not limited thereto, and the axial thickness of the edge portion may be the same as the axial thickness of the flange portion, or may be smaller than the axial thickness of the flange portion.

In the above embodiment, it has been described that the tip on the radially outer side of the edge portion 51b is located radially outward of the radially outer side of the protruding portion 41a. However, the present invention is not limited thereto, and the tip on the radially outer side of the edge portion 51b may be at the same position as the radially outer side of the protruding portion, or may be outside the radially outer side of the protruding portion. In addition, the radially outer tip of the protruding portion may be covered with the resin portion.

In the above embodiment, it has been described that the first mold 10 and the second mold 20 have specific structures. That is, the first mold 10 includes the base mold 12 and the side molds 11a and 11b. More specifically, the second mold 20 includes the central mold 21, the inner molds 22a and 22b, and the outer molds 23a and 23b. However, the present invention is not limited thereto, and each of the first mold and the second mold may be configured as a single member or may further include another member.

In the above embodiment, the inner mold 22b of the second mold 20 has the resin injection portion 24, but the present invention is not limited thereto. Any member of the second mold and the first mold may have the resin injection portion.

In the embodiment described above, in the rotor cover attaching step, the rotor core 31 and the rotor magnet 32 are inserted into the rotor cover 40 while the rotor magnet 32 is positioned with respect to the rotor core 31. The present invention is not limited thereto, and a work-in-process in which a rotor magnet is previously fixed to a rotor core with an adhesive or the like may be inserted into the rotor cover.

In the above embodiment, it has been described that the rotation prevention portion 54 and the retaining portion 53 are formed as the restricting portions by the resin injection process, but the formation of the restricting portions may be omitted. Further, the formation of the inter-magnet filling portion and the rib rear resin portion may be omitted.

The present invention is applicable to a rotor and a motor in which the rotor is incorporated.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotor comprising:
a rotor core having a columnar shape and extending in an axial direction; and
a rotor cover that covers an outer side in a radial direction of the rotor core,
wherein the rotor cover includes:
a protruding portion protruding to one side in the axial direction with respect to a one-side end surface in the axial direction of the rotor core; and
a flange portion extending outward in the radial direction at a one-side end portion in the axial direction of the protruding portion.

2. The rotor according to claim 1, further comprising a resin portion that covers the one-side end surface in the axial direction of the rotor core,
wherein the resin portion includes an edge portion on an outer side in the radial direction, the edge portion being in contact with one side in the axial direction of the flange portion.

3. The rotor according to claim 2, wherein the resin portion includes a side portion that is in contact with an inner side in the radial direction of the protruding portion.

4. The rotor according to claim 2, wherein thickness of the edge portion in the axial direction is equal to or larger than a thickness of the flange portion in the axial direction.

5. The rotor according to claim 2, wherein a tip on an outer side in the radial direction of the edge portion is located outward in the radial direction of the outer side in the radial direction of the protruding portion.

6. The rotor according to claim 2, wherein the flange portion and the edge portion are located in an entire circumferential direction of the rotor cover.

7. A rotor manufacturing apparatus for manufacturing a rotor in which an outer side in a radial direction of a rotor core having a columnar shape and extending in an axial direction is covered with a rotor cover and a one-side end surface in the axial direction of the rotor core is covered with a resin portion, the rotor manufacturing apparatus comprising:
a first mold that holds the rotor cover covering the outer side in the radial direction of the rotor core in a state in which a protruding portion protrudes to one side in the axial direction with respect to the one-side end surface in the axial direction of the rotor core, and a flange portion extending outward in the radial direction at a one-side end portion in the axial direction of the protruding portion protrudes outward in the radial direction;
a second mold that is located on one side in the axial direction of the first mold so as to be relatively movable in the axial direction with respect to the first mold, and forms spaces between the second mold and the one-side end surface in the axial direction of the rotor core and between the second mold and the one side in the axial direction of the flange portion of the rotor cover respectively, in a state in which the rotor core and the rotor cover are sandwiched between the second mold and the first mold; and
a resin injection portion for injecting resin into the spaces,
wherein the first mold includes a first pressing portion for pressing another side in the axial direction of the flange portion of the rotor cover in a state where the rotor core and the rotor cover are sandwiched, and
the second mold includes a second pressing portion for pressing one side in the axial direction of the flange portion of the rotor cover in a state where the rotor core and the rotor cover are sandwiched.

8. A rotor manufacturing method for manufacturing a rotor in which an outer side in a radial direction of a rotor core having a cylindrical shape and extending in an axial direction is covered with a rotor cover, and a one-side end surface in the axial direction of the rotor core is covered with a resin portion, the rotor manufacturing method comprising:
a rotor cover attaching step of inserting the rotor core into the rotor cover, the rotor cover including a side wall portion whose length in the axial direction is larger than a length in the axial direction of the rotor core and including a flange portion extending outward in the radial direction at a one-side end portion in the axial direction of the side wall portion, and positioning the one-side end portion in the axial direction of the rotor cover at a position protruding with respect to the one-side end surface in the axial direction of the rotor core;
a mold disposition step of sandwiching the rotor core and the rotor cover by a first mold and a second mold to form spaces with the one-side end surface in the axial direction of the rotor core and with one side in the axial direction of the flange portion of the rotor cover respectively, and clamping the flange portion; and
a resin injection step of injecting resin into the spaces.
